(19) United States
(12) Patent Application Publication
(10) Pub. No.: US 2026/0109308 A1
(43) Pub. Date: Apr. 23, 2026

(54) SYSTEMS AND METHODS FOR PREDICTIVE AND DYNAMIC ENERGY MANAGEMENT

(71) Applicant: Via Fortuna, LLC, Wilmington, DE (US)

(72) Inventor: Satyan Chandra, Sunnyvale, CA (US)

(21) Appl. No.: 19/361,598

(22) Filed: Oct. 17, 2025

Related U.S. Application Data
(60) Provisional application No. 63/708,921, filed on Oct. 18, 2024.

(51) Int. Cl. B60R 16/023; G01C 21/36

(52) U.S. Cl. CPC B60R 16/0238; G01C 21/3691

(57) ABSTRACT

Disclosed embodiments may include a systems and methods for predictive and dynamic energy management for a vehicle. The disclosed embodiments may include receiving input data. The system may determine, using a first machine learning model, an anticipated destination of the vehicle based on at least a portion of the input data. Furthermore, the disclosed embodiments may include determining that the vehicle is anticipated to arrive at the anticipated destination within a predetermined time threshold. In response to determining that the vehicle is anticipated to arrive at the anticipated destination within the predetermined time threshold, the system may change an operating mode of the vehicle from a first operating mode to a second operating mode, wherein the second operating mode is an energy conservation mode.

### CROSS-REFERENCE TO RELATED APPLICATIONS

This application claims priority, under 35 U.S.C. § 119 (e), to U.S. Provisional Patent Application No. 63/708,921, filed Oct. 18, 2024, the entire contents of which is fully incorporated herein by reference.

### FIELD

The disclosed technology relates to systems and methods for predictive and dynamic energy management. Specifically, this disclosed technology relates to using machine learning models to manage the energy consumption of devices in vehicles in order to conserve energy that would otherwise be wasted.

### BACKGROUND

Typical vehicles (e.g., automobiles, such as battery electric automobiles) keep their low voltage power consuming devices (such as pumps, seat heaters, fans, other motors) on and enabled until the vehicle reaches end of drive, the driver exits, and the driver turns off the vehicle. This results in a lot of wasted energy, especially thermal energy, as battery power may be consumed to heat or cool various vehicle systems until the vehicle is turned off. Over time, keeping these systems running when they are otherwise not needed results in up to hundreds of watts per vehicle of wasted power (and up to several mega-watt hours of wasted energy per vehicle on a yearly scale). Using this additional power adds to the cost of operating the vehicle (e.g., through fuel usage or AC/DC charging requirements), increases emissions (e.g., direct or indirect greenhouse gas emissions), and reduces the life of vehicle components (e.g., by stressing heating or cooling hardware).

Accordingly, there is a need for improved systems and methods for predictive and dynamic energy management. Embodiments of the present disclosure are directed to this and other considerations.

### SUMMARY

Disclosed embodiments may include a system for predictive and dynamic energy management. The system may include one or more processors, and memory in communication with the one or more processors and storing instructions that, when executed by the one or more processors, are configured to cause the system to provide predictive and dynamic energy management. The system may include receiving input data comprising a location of the vehicle, a speed of the vehicle, a direction of vehicle, and vehicle status information. The system may further include determining, in real-time, using a first machine learning model, an anticipated destination of the vehicle based on at least a portion of the input data. Additionally, the system may include determining whether the vehicle is within a predetermined distance of the anticipated destination or whether the vehicle is anticipated to arrive at the anticipated destination within a predetermined time. In response to determining that the vehicle is within the predetermined distance of the anticipated destination or determining that the vehicle is anticipated to arrive at the anticipated destination within the predetermined time, the system may alter the performance of the vehicle using one or more preset tables, the one or more preset tables being used to reduce a power output of one or more drive units or one or more climate control systems.

Disclosed embodiments may include a system for predictive and dynamic energy management. The system may include one or more processors, and memory in communication with the one or more processors and storing instructions that, when executed by the one or more processors, are configured to cause the system to provide predictive and dynamic energy management. The system may include receiving input data. Furthermore, the system may include determining, using a first machine learning model, an anticipated destination of the vehicle based on at least a portion of the input data. Additionally, the system may include determining whether the vehicle is anticipated to arrive at the anticipated destination within a predetermined time. In response to determining that the vehicle is anticipated to arrive at the anticipated destination within the predetermined time, the system may change an operating mode of the vehicle from a first operating mode to a second operating mode, wherein the second operating mode is an energy conservation mode.

Disclosed embodiments may include a method for predictive and dynamic energy management. The method may include receiving input data. Additionally, the method may include determining, using a first machine learning model, an anticipated destination of the vehicle based on at least a portion of the input data. Furthermore, the method may include determining that the vehicle is anticipated to arrive at the anticipated destination within a predetermined time threshold. In response to determining that the vehicle is anticipated to arrive at the anticipated destination within the predetermined time threshold, the method may include changing an operating mode of the vehicle from a first operating mode to a second operating mode, wherein the second operating mode is an energy conservation mode.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for predictive and dynamic energy management in accordance with certain embodiments of the disclosed technology.

FIG. 2 is a flow diagram illustrating an exemplary method for predictive and dynamic energy management in accordance with certain embodiments of the disclosed technology.

FIG. 3 is a block diagram of an example energy management system used to provide predictive and dynamic energy management, according to an example implementation of the disclosed technology.

FIG. 4 is a block diagram of an example system that may be used for calibration and training systems to provide predictive and dynamic energy management, according to an example implementation of the disclosed technology.

FIG. 5 is a block diagram of a vehicle system that may be used for predictive and dynamic energy management, according to an example implementation of the disclosed technology.

FIG. 6 is a graph of power usage of a vehicle according to an example implementation of the disclosed technology.

### DETAILED DESCRIPTION

Disclosed embodiments include systems and methods for managing energy consumption of an assortment of devices within a vehicle. The present disclosure includes systems and methods for determining a destination of a user, determining when the user will reach the destination, and based on the time and/or distance to the destination proactively instructing vehicle systems to perform actions to save energy and/or lower emissions. In some embodiments, the actions may include reducing heating or cooling power and energy to save energy and lower emissions.

Examples of the present disclosure related to systems and methods for predictive and dynamic energy management. More particularly, the disclosed technology relates to determining an anticipated destination of a vehicle based on inputted vehicle data and performing actions to save energy and/or lower emissions of the vehicle based on the anticipated destination. The systems and methods described herein utilize, in some instances, machine learning models, which are necessarily rooted in computers and technology. Machine learning models are a unique computer technology that involves training models to complete tasks and make decisions. Using a machine learning model in this way may allow the system to predict the destination of a vehicle and then selectively change vehicle performance based on the predicted destination. This is a clear advantage and improvement over prior technologies that because the system allows the vehicle to save additional energy, lower emissions, and have better features over conventional designs. Overall, the systems and methods disclosed have significant practical applications in the vehicle energy management field because of the noteworthy improvements of utilizing one or more machine learning models to predict a destination and proactively alter vehicle performance based on the predicted destination, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

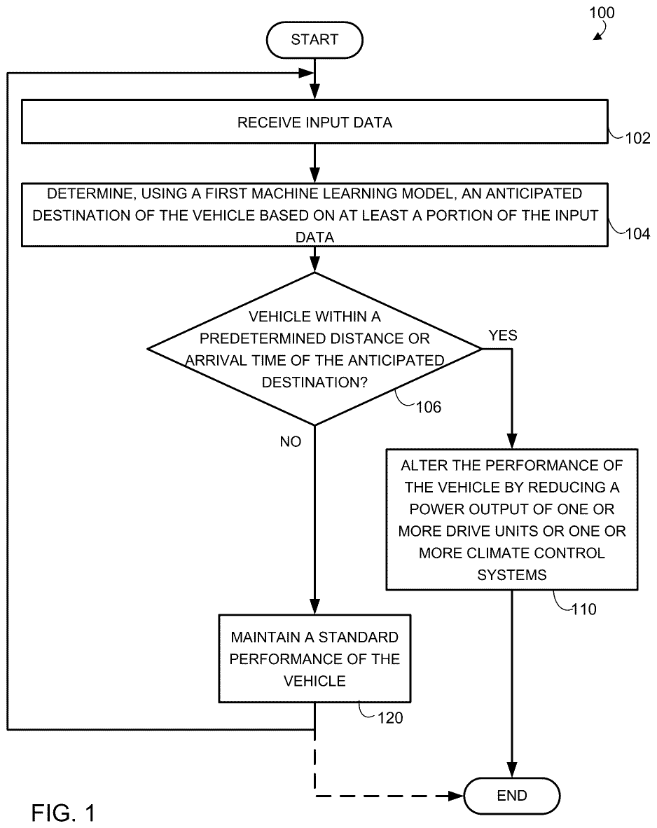

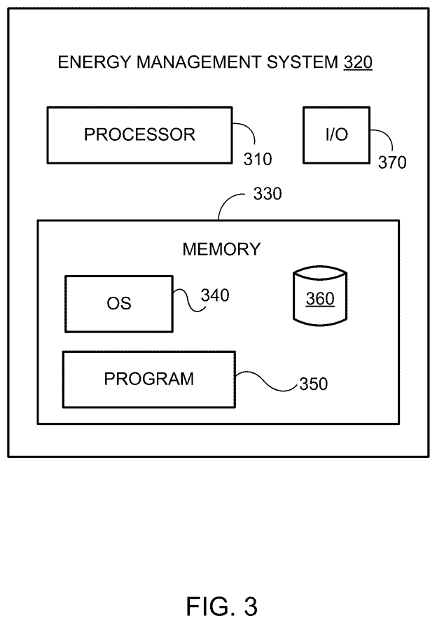

FIG. 1 is a flow diagram illustrating an exemplary method 100 for predictive and dynamic energy management, in accordance with certain embodiments of the disclosed technology. The steps of method 100 may be performed by one or more components of the vehicle system 500 (e.g., energy management system 320), as described in more detail with respect to FIGS. 3-5. Method 100 may be continuously repeated and iterated as the vehicle travels. Method 100 may be used with multiple types of vehicles include electric vehicles (EVs), plug-in hybrid vehicles (PHEV), and internal combustion engine (ICE) vehicles.

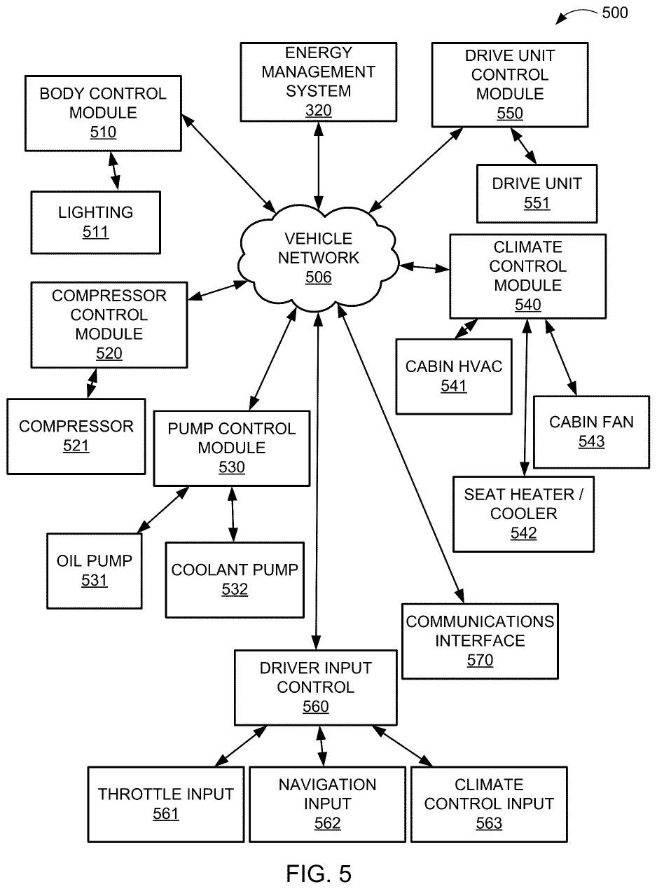

In block 102, the energy management system 320 may receive input data. The input data may comprise data received from different parts or modules of vehicle system 500 (as shown in FIG. 5). Accordingly, the input data may include a location of the vehicle, a speed or velocity of a vehicle, and a direction of the vehicle (e.g., as determined via a cellular network such as 3G, LTE, or 5G, WiFi, or global positioning satellite (GPS)). The input data may include data provided a mobile device (e.g., a smartphone) of a driver or passenger connected to the vehicle (e.g., via communications interface 570 of FIG. 5), which may be predictive of a driver's schedule. The input data may include vehicle status information received from one or more modules of the vehicle (e.g., from body control module 510, compressor control module 520, pump control module 530, climate control module 540, drive unit control module 550, driver input control 560, and communications interface 570 of FIG. 5). For example, the driver input control 560 (FIG. 5) may receive a throttle input 561 (FIG. 5) which may be transmitted to energy management system 320 over the vehicle network 506 (FIG. 5). In another example, the climate control module 540 (FIG. 5) may transmit a current power consumption to the energy management system 320 via the vehicle network 506 (FIG. 5). The input data may be constantly received and updated in real-time. The input data may also include a throttle setting of the vehicle and a temperature setting of the climate control of the vehicle.

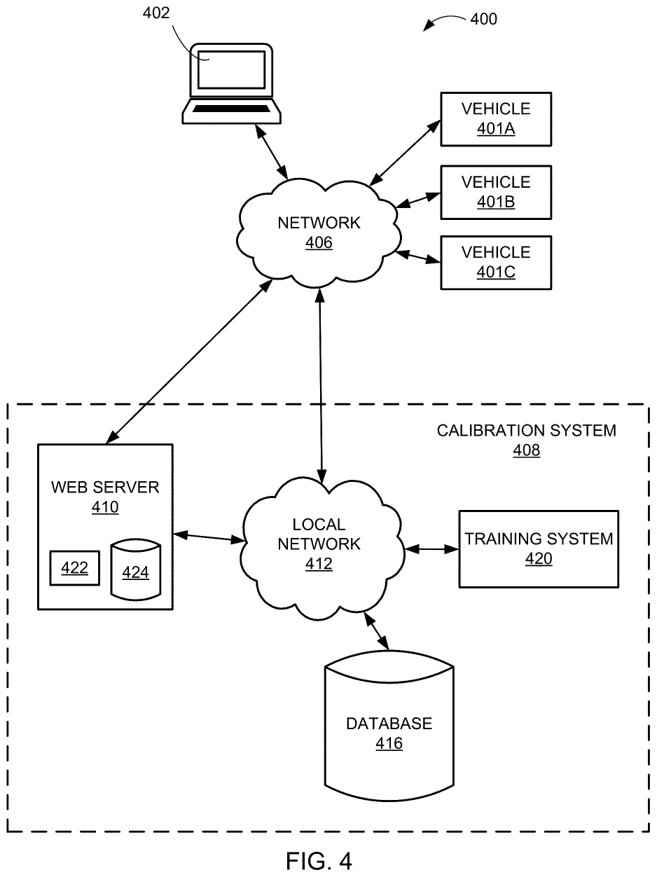

In some embodiments, the energy management system 320 may store the received input data in a database either part of energy management system 320, external to energy management system 320 and connected to energy management system 320 via the vehicle network 506 (FIG. 5), or external to energy management system 320 and stored on external database (e.g., database 416 of FIG. 4). Input data stored by the energy management system 320 may be retrieved at a later time as historical data or past data. Energy management system 320 may also receive input data regarding an aggregation of vehicles (e.g., via calibration system 408 or training system 420 of FIG. 4).

In some embodiments, energy management system 320 may also be capable of requesting data. For example, based on a current location, the energy management system 320 may request weather data from an external server (e.g., indicating the temperature and/or conditions). Energy management system 320 may also request data from assorted modules of vehicle system 500. For example, the energy management system 320 may request if a destination has been inputted to the navigation system, and the distance and/or time to the destination. In some embodiments, a navigation system may be configured to broadcast the distance and/or time to any inputted destination to the energy management system 320 if known.

In some embodiments, energy management system 320 may aggregate the input data to calculate a total energy consumption or calculate the energy consumption of one or more specific energy systems (e.g., one or more drive units, one or more cooling or heating systems, one or more climate control systems). The energy management system 320 may determine a vehicle load from the input data. The vehicle load may include a passenger load (e.g., a number of passengers, or an approximate mass of passengers), a cargo load, a towing load, and increases in load from increased vehicle drag (e.g., windows open, or a vehicle with a roof rack).

In block 104, the energy management system 320 may determine an anticipated destination of the vehicle based on at least a portion of the input data. In some embodiments, the energy management system 320 may utilize one or more machine learning models in order to determine the anticipated destination of the vehicle. The one or more machine learning models may receive all or a subset of the input data from block 102. The one or more machine learning models may output an anticipated destination of the vehicle based on the input data. The anticipated destination may include one or more anticipated destinations (e.g., a first destination, a second destination, and so on). The anticipated destination may be chosen based on one or more confidence intervals (e.g., the anticipated destination with this highest confidence is chosen).

The energy management system 320 may determine the anticipated destination based on a variety of the input data received in block 102. Some input data may be significantly indicative of an anticipated destination of the vehicle. For example, if a driver has input a destination into the vehicle navigation system, then energy management system 320 may have a high confidence that the destination input in the vehicle navigation system is the anticipated destination. Furthermore, the energy management system 320 may be configured to recognize trends from prior vehicle data or user data (e.g., time of the day, day of the month, location, or routes). For example, if the driver of the vehicle historically leaves his home and goes to work every weekday between 7:42 AM and 8:04 AM, then energy management system 320 may predict that future trips leaving on weekdays between those times has a high likelihood of the anticipated destination being the workplace of the driver. In other embodiments, the energy management system 320 may be configured to recognize common routes. For example, the energy management system 320 may receive input data indicating that even though a route is not the most direct or fastest route, the driver takes it regularly before traveling to the grocery store. Therefore, the energy management system 320 may determine that the anticipated destination is the grocery store.

Accordingly, the energy management system 320 may be capable of being trained based on historical data (e.g., input data received in the past). The energy management system 320 may be capable of training the one or more machine learning models based on the historical data. Furthermore, newly received input data may be capable of updating or retraining the one or more machine learning models. Some embodiments may include receiving aggregated data from calibration system 408 (FIG. 4) or training system 420 (FIG. 4). The aggregated data may comprise training data from a variety of similar vehicles (e.g., energy consumption data, route data). Energy management system 320 may utilize the data from calibration system 408 (FIG. 4) or training system 420 (FIG. 4) to further enhance the accuracy or reliability of determining an anticipated destination or other features.

In some embodiments, the energy management system 320 may be required to determine the anticipated destination above a confidence threshold. The confidence threshold may be predetermined (e.g., set by programming, within manufacturer vehicle settings, within user settings) or dynamic (e.g., changing according to the input data, such as the weather). In some embodiments, if the energy management system 320 is unable to determine an anticipated destination above the confidence threshold, then the method may end. In some embodiments, if the energy management system 320 determines the anticipated destination above the confidence threshold, the method may continue to block 106.

In some embodiments, the energy management system 320 may continuously update and determine the anticipated destination of the vehicle in real-time. For example, if the energy management system 320 receives GPS data that indicates that the vehicle has deviated from a route to the determined anticipated destination, the energy management system 320 may determine whether the prior determined anticipated destination is still the destination of the trip. If the prior anticipated destination differs from a newly determined anticipated destination from the new input data, the energy management system 320 may update the anticipated destination.

In block 106, the energy management system 320 may determine whether the vehicle is anticipated to arrive at the predetermined destination within a predetermined time. In some embodiments, at block 106, the energy management system 320 may determine whether the vehicle is within a predetermined distance of the anticipated destination. Based on the output of block 104, the energy management system 320 may use the anticipated destination to determine if the vehicle is within one or more thresholds that could result in saving energy. The one or more thresholds may include time thresholds from the anticipated destination or distance thresholds from the anticipated destination. The one or more thresholds may be static (e.g., fixed to a time or distance) or dynamic (e.g., changing based on one or more factors from the input data such as the weather). Additionally, the one or more thresholds may be predetermined. If the energy management system 320 determines that the vehicle is not within the one or more thresholds (e.g., the vehicle is not within a predetermined distance of the anticipated destination or the vehicle is not anticipated to arrive within a predetermined), then the method may continue to block 120. If the energy management system 320 determines that the vehicle is within the one or more thresholds, (e.g., the vehicle is within a predetermined distance of the anticipated destination or the vehicle is anticipated to arrive within a predetermined time), then the method may continue to block 110.

In some embodiments, the one or more thresholds may be three thresholds. A first threshold may be five minutes before the anticipated end of the drive (e.g., five minutes until reaching the anticipated destination). A second threshold may be two minutes before the anticipated end of the drive (e.g., two minutes until reaching the anticipated destination). A third threshold may be one minute before the anticipated end of the drive (e.g., one minute until reaching the anticipated destination). The energy management system 320 may separately determine whether each threshold is reached.

In block 110, the energy management system 320 may alter the performance of the vehicle. If the energy management system 320 determines that the vehicle is within the one or more thresholds (e.g., the vehicle is within a predetermined distance of the anticipated destination or the vehicle is anticipated to arrive within a predetermined time) in block 106, then in block 110, the energy management system 320 may alter characteristics of the vehicle to save energy. For example, typically when driving, the vehicle maintains set parameters for continuously maintaining cooling and/or heating capacity to allow for continuous use (and accommodate changes in driving behavior, such as a sudden acceleration). Since the energy management system 320 here has determined that soon the drive will be ending, energy does not need to be expended to continue to maintain the cooling and/or heating capacity to accommodate continued use. The energy management system 320 relies on the already inbuilt high levels of thermal mass built into the vehicle system (e.g., vehicle system 500 of FIG. 5) to provide the cooling and/or heating needs of the vehicle while selectively reducing the power to or shutting down certain vehicle components. Accordingly, energy management system 320 can interpret the vehicle data to determine the amount of thermal headroom available (e.g., for the cabin temperature, batteries, and drive units) assuming that the drive is ending within a preset amount of time rather than assuming that the drive is always going to continue (as is assumed in conventional vehicles). By leveraging the amount of thermal headroom, and assuming that the drive is ending rather than continuing, the energy management system 320 may selectively reduce the power of heating and cooling components, pumps, coolers, and fans that manage the thermal characteristics of different components (e.g., batteries, drive units, climate control) without damaging the components and without overly affecting the user experience. This allows energy management system 320 to save energy by stopping or limiting these thermal controls.

For example, the climate control system in a vehicle may be set for 65 degrees, the outside temperature may be 70 degrees, and the current temperature in the vehicle is 65 degrees. At the end of the drive, energy management system 320 may calculate that with a load of a single person, accommodating for the difference in the indoor and outdoor temperature, it would take 6 minutes to increase the temperature from 65 degrees to 66 degrees in the vehicle cabin. Therefore, energy management system 320 may determine that it can instruct the climate control to reduce power by 50%, because the temperature may increase, but at a minimal rate, and it saves energy while minimally affecting the user.

In some embodiments, the energy management system 320 may alter the performance of the vehicle by reducing the power output of one or more drive units or reducing the power output of one or more climate control systems. This may be dependent on the one or more thresholds the energy management system 320 determines have been met in block 106. For example, at a first threshold (five minutes before the anticipated end of the drive), the energy management system 320 may reduce compressor power to 50% of typical, reduce battery cooling pump power to 50% of typical, oil pump power of one or more drive units to 40% of typical, and the cabin heating, ventilation, and air conditioning (HVAC) power to 70% of typical. At the second threshold (two minutes before the anticipated end of the drive), the energy management system 320 may reduce drive unit coolant pump power to 30% of typical, compressor power to 25% of typical, battery coolant pump power to 25% of typical, cabin HVAC power to 50% of typical, the seat heater or seat cooling if on to 30% of typical, the cabin fan to 50% of typical, and turns off the oil pump of the one or more drive units. At the third threshold (one minute before the anticipated end of the drive), the energy management system 320 may turn off (or reduce to 5% of typical power) the drive unit coolant pump, compressor, battery coolant pump, cabin HVAC, seat heating and cooling if on, and cabin fan if on. To the user, most of these actions are invisible and largely un-noticeable. This also extends the life of hardware, as components do not have to work as much.

In some embodiments, altering the performance of the vehicle may be controlled by one or more tables. The tables may contain power reductions on a specific component level. In some embodiments, the reductions may be staged in different levels (e.g., at a first level, components associated with the drive unit reduce power, and at a second level, the components associated with the climate control reduce power). The tables may be configured to be specific to a vehicle model, vehicle type, or individual vehicle components. For example, the tables may be configured based on the inbuilt levels of thermal mass of a specific vehicle type (e.g., a small economy car may have different thermal characteristics than a large pickup truck, therefore allowing the pickup truck to more aggressively reduce the power of systems than the small economy car). In some embodiments, altering the performance of the vehicle may be controlled by one or more second machine learning models. The one or more second machine learning models may be trained through the input data received from the vehicle (e.g., received input data regarding thermal characteristics of components after reducing cooling power). This may allow the energy management system 320 to optimize energy saving to characteristics of a specific vehicle. The one or more second machine learning models may also be calibrated or trained through data received from other vehicles (e.g., via calibration system 408 of FIG. 4 and training system 420 of FIG. 4).

The energy management system 320 may adjust for individual ride characteristics. For example, if the energy management system 320 determines that there is only one driver in the vehicle versus a driver and multiple passengers from load data (e.g., vehicle torque requirements, seat or seat belt sensors), the energy management system 320 may leave the air conditioning at a higher setting (or reduce the air conditioning settings more slowly) as the trip ends because the energy management system 320 may calculate that more passengers are likely to increase the temperature of the cabin faster than a single person. Furthermore, in a multi-zone air conditioning system with a single driver, the energy management system 320 may shut down the unused zones more heavily than the driver's zone.

The energy management system 320 may utilize outdoor temperature data (either via a temperature sensor) or via downloaded weather data to calculate the amount of thermal headroom available within a vehicle system. For example, energy management system 320 may need to maintain a high coolant pump power to continue to cool the battery and drive units if the outdoor temperature is 110 degrees Fahrenheit in Arizona versus 40 degrees Fahrenheit in Maine. Energy management system 320 may also use the route in determining the thermal needs of the vehicle (e.g., a route with high speed interstate travel before ending may require a higher coolant pump power or higher oil pump power than one on city streets).

While the vehicle has altered performance characteristics as energy management system 320 prepares for the drive to end, the system may restrict certain vehicle features for the user. For example, the user may not be able to request full power from the one or more drive units. Furthermore, the user may not be able to request certain climate control settings. In some embodiments, if a request from the user is outside the parameters than may be provided when the vehicle is within the reduced power settings of block 110, the energy management system 320 may revert to a standard vehicle operating performance (e.g., if the user requests full acceleration from the drive units, the energy management system 320 may allow coolant pumps and oil pumps to the drive units and batteries to resume typical operation). Furthermore, in the event any safety limit is exceeded (e.g., if the battery begins to overheat), the energy management system 320 may allow the vehicle to return to standard operating performance so that normal thermal management may be restored to protect the hardware. In some embodiments, the altered performance characteristics may resume after a predetermined amount of time since an overriding event (e.g., an acceleration request or overheating component).

In some embodiments, the altered performance characteristics of the vehicle are used until the drive ends. If the drive follows a different route than expected, the energy management system 320 may verify that the thresholds of block 106 are still met. If the thresholds are no longer met, the altered performance characteristics may be stopped and the vehicle may return to having standard performance characteristics.

In block 120, the energy management system 320 may maintain a standard performance of the vehicle. If the energy management system 320 determines that the vehicle is not within the one or more thresholds (e.g., the vehicle is not within a predetermined distance of the anticipated destination or the vehicle is not anticipated to arrive within a predetermined time) in block 106, then in block 120, the energy management system 320 may maintain standard vehicle performance parameters. When following the standard vehicle parameters, the vehicle may conform to standard operating procedure and the user may have typical functionality associated with all vehicle systems. For example, if the user is driving from Charlotte, North Carolina to Raleigh, North Carolina, and has just left Charlotte, the energy management system 320 would maintain the standard operating mode of the vehicle (as described in block 120) until the vehicle was within the threshold of anticipated destination (Raleigh).

As the vehicle is driven to a destination, the energy management system 320 may continuously receive new input data at block 102, which may be further evaluated to confirm the anticipated destination (or change to a new anticipated destination) and may be compared to the one or more thresholds in block 106. As the drive progresses, the energy management system 320 may reevaluate new input data as it is received, and once the one or more thresholds of block 106 are met (indicating the end of a drive is nearing), then the method may proceed from block 106 to block 110.

In some embodiments, the energy management system 320 may allow the vehicle to maintain the standard performance of block 120 until the end of the drive (indicated by the dashed arrow). This may occur when a user selects a setting within the vehicle indicating that standard performance should always be maintained. This may also occur if the energy management system 320 is unable to predict an anticipated destination beyond the confidence threshold (as described with reference to block 104). Furthermore, in some embodiments, if the user reaches the anticipated destination and continues traveling, the system may be configured to maintain the standard performance of the vehicle until the drive has ended.

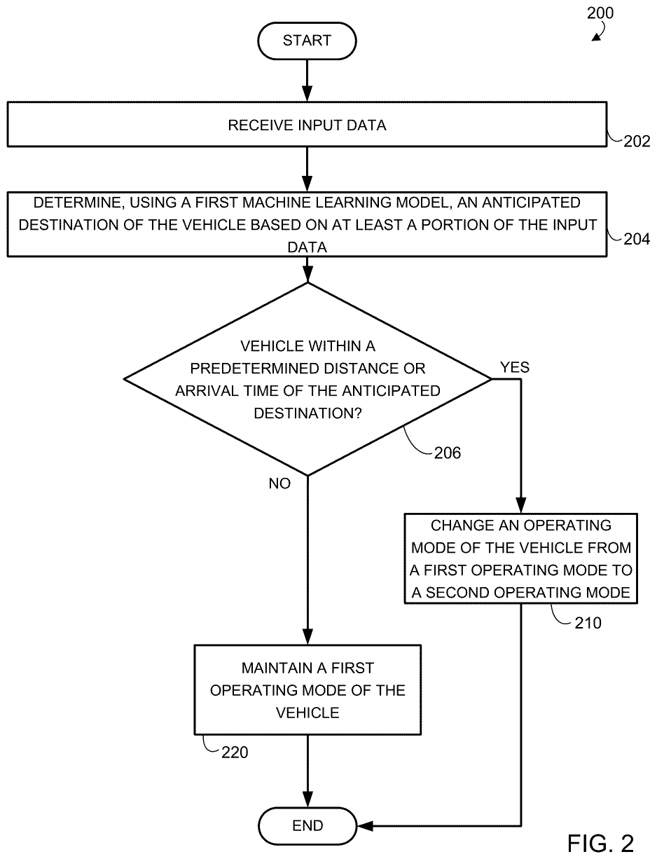

FIG. 2 is a flow diagram illustrating an exemplary method 200 for predictive and dynamic energy management, in accordance with certain embodiments of the disclosed technology. The steps of method 200 may be performed by one or more components of the system 500 (e.g., energy management system 320), as described in more detail with respect to FIGS. 3-5.

Method 200 of FIG. 2 is similar to method 100 of FIG. 1. The descriptions of blocks 202, 204, and 206 in method 200 are similar to the respective descriptions of blocks 102, 104, and 106 of method 100 and are not repeated herein for brevity. However, blocks 210 and 220 are different from blocks 110 and 120 and are described below. Method 200 may be continuously repeated and iterated as the vehicle travels. Method 200 may be used with multiple types of vehicles include electric vehicles (EVs), plug-in hybrid vehicles (PHEV), and internal combustion engine (ICE) vehicles.

In block 210, the energy management system 320 may change an operating mode of the vehicle from a first operating mode to a second operating mode. For method 200, a first operating mode may be a standard or typical operating mode. The first operating model may be the operating mode a typically operates a vehicle in. The first operating mode may provide a standard performance of a vehicle or vehicle system. A second operating mode may be an energy-saving operating mode. Accordingly, in a second operating mode, the energy management system 320 may alter the performance of the vehicle when the energy management system 320 anticipates the end of a drive. This may involve reducing the power output of one or more systems, accessories, or components of the vehicle. The second operating mode may have one or more levels or tiers. The one or more levels or tiers may be associated with different energy-reducing control methodologies, related to, for example, a specific system or component. Accordingly, the energy-saving operating mode may be specific to modifying the operation of components or groups of components that are imperceptible to the user or minimally perceptible to the user. This way, the vehicle is able to save energy while not compromising the driving experience at the end of the drive.

If the energy management system 320 determines that the vehicle is within the one or more thresholds (e.g., the vehicle is within a predetermined distance of the anticipated destination or the vehicle is anticipated to arrive within a predetermined time) in block 206, then in block 210, the energy management system 320 may change the vehicle from the first operating mode to the second operating mode. Block 210 is otherwise similar in its respective description to block 110 and is not repeated herein for brevity.

In block 220, the energy management system 320 may maintain a first operating mode of the vehicle. If the energy management system 320 determines that the vehicle is not within the one or more thresholds (e.g., the vehicle is not within a predetermined distance of the anticipated destination or the vehicle is not anticipated to arrive within a predetermined time) in block 206, then in block 210, the energy management system 320 may keep the vehicle in the first operating mode to maintain full functionality. As the energy management system 320 continues to travel, receives additional input data, or receives requests from the user, the vehicle may change back and forth from the second operating mode to the first operating mode and vice versa. Block 220 is otherwise similar in its respective description to block 120 and is not repeated herein for brevity.

FIG. 3 is a block diagram of an example energy management system 320 used to analyze input data from the vehicle and determine when to change operating parameters in order to save energy according to an example implementation of the disclosed technology. According to some embodiments, the user device 402, training system 420, and web server 410, as depicted in FIG. 4, and the body control module 510, compressor control module 520, pump control module 530, climate control module 540, drive unit control module 550, driver input control 560, and communications interface 570, as depicted in FIG. 5 and described below, may have a similar structure and components that are similar to those described with respect to energy management system 320 shown in FIG. 3. As shown, the energy management system 320 may include a processor 310, an input/output (I/O) device 370, a memory 330 containing an operating system (OS) 340 and a program 350. In certain example implementations, the energy management system 320 may be a single server or may be configured as a distributed computer system including multiple servers or computers that interoperate to perform one or more of the processes and functionalities associated with the disclosed embodiments. In some embodiments energy management system 320 may be one or more servers from a serverless or scaling server system. In some embodiments, the energy management system 320 may further include a peripheral interface, a transceiver, a mobile network interface in communication with the processor 310, a bus configured to facilitate communication between the various components of the energy management system 320, and a power source configured to power one or more components of the energy management system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the energy management system 320 may include one or more storage devices configured to store information used by the processor 310 (or other components) to perform certain functions related to the disclosed embodiments. In one example, the energy management system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The energy management system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the energy management system 320 may include the memory 330 that may include one or more programs 350 to perform one or more functions of the disclosed embodiments. For example, in some embodiments, the energy management system 320 may additionally manage dialogue and/or other interactions with the customer via a program 350.

The processor 310 may execute one or more programs 350 located remotely from the energy management system 320. For example, the energy management system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include an energy management system database 360 for storing related data to enable the energy management system 320 to perform one or more of the processes and functionalities associated with the disclosed embodiments.

The energy management system database 360 may include stored data relating to status data (e.g., average session duration data, location data, idle time between sessions, and/or average idle time between sessions) and historical status data. According to some embodiments, the functions provided by the energy management system database 360 may also be provided by a database that is external to the energy management system 320, such as the database 416 as shown in FIG. 4 or in other vehicle modules shown in FIG. 5.

The energy management system 320 may also be communicatively connected to one or more memory devices (e.g., databases) locally or through a network. The remote memory devices may be configured to store information and may be accessed and/or managed by the energy management system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The energy management system 320 may also include one or more I/O devices 370 that may comprise one or more interfaces for receiving signals or input from devices and providing signals or output to one or more devices that allow data to be received and/or transmitted by the energy management system 320. For example, the energy management system 320 may include interface components, which may provide interfaces to one or more input devices, such as one or more keyboards, mouse devices, touch screens, track pads, trackballs, scroll wheels, digital cameras, microphones, sensors, and the like, that enable the energy management system 320 to receive data from a user (such as, for example, via the user device 402).

In examples of the disclosed technology, the energy management system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The energy management system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The energy management system 320 may be configured to adjust model parameters during training. Model parameters may include weights, coefficients, offsets, or the like. Training may be supervised or unsupervised.

The energy management system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The energy management system 320 may be configured to optimize statistical models using known optimization techniques.

Furthermore, the energy management system 320 may include programs configured to retrieve, store, and/or analyze properties of data models and datasets. For example, energy management system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The energy management system 320 may include algorithms to determine a data type, key-value pairs, row-column data structure, statistical distributions of information such as keys or values, or other property of a data schema may be configured to return a statistical profile of a dataset (e.g., using a data-profiling model). The energy management system 320 may be configured to implement univariate and multivariate statistical methods. The energy management system 320 may include a regression model, a Bayesian model, a statistical model, a linear discriminant analysis model, or other classification model configured to determine one or more descriptive metrics of a dataset. For example, energy management system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The energy management system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, energy management system 320 may be configured to generate a similarity metric representing a measure of similarity between data in a dataset. A similarity metric may be based on a correlation, covariance matrix, a variance, a frequency of overlapping values, or other measure of statistical similarity.

The energy management system 320 may be configured to generate a similarity metric based on data model output, including data model output representing a property of the data model. For example, energy management system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The energy management system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The energy management system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, energy management system 320 is configured to generate and/or train a classification model to classify a dataset, consistent with disclosed embodiments.

The energy management system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via weighted connections. Prediction models may additionally or alternatively include classification and regression trees, or other types of models known to those skilled in the art. To generate prediction models, the energy management system may analyze information applying machine-learning methods.

While the energy management system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the energy management system 320 may include a greater or lesser number of components than those illustrated.

FIG. 4 is a block diagram of an example system that may be used to calibrate and train energy management system 320. Calibration system 408, according to an example implementation of the disclosed technology, may interact with different vehicles in order to provide data and/or aid in the training of energy management system 320. The components and arrangements shown in FIG. 4 are not intended to limit the disclosed embodiments as the components used to implement the disclosed processes and features may vary. As shown, calibration system 408 may interact with one or more vehicles 401a, 401b, 401c, and a user device 402 via a network 406. In certain example implementations, the calibration system 408 may include a local network 412, a training system 420, a web server 410, and a database 416.

In some embodiments, calibration system 408 may receive and transmit data to one or more vehicles 401a, 401b, 401c via network 406. The one or more vehicles 401a, 401b, 401c may each include an energy management system 320 allowing for energy conservation practices on each vehicle. Each vehicle 401a, 401b, 401c may interact with calibration system 408 in order to train or refine energy management system 320. The calibration system 408 may be used to crowdsource data from multiple vehicles and use the crowdsourced data to enhance the energy efficiency of all the vehicles 401a, 401b, 401c by updating energy management system 320 or via training one or more machine learning models within energy management system 320.

In some embodiments, a user may operate the user device 402, which may be used to control calibration system 408. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the calibration system 408. In some embodiments, the user device 402 may include or incorporate electronic communication devices for hearing or vision impaired users.

Users of user device 402 may be employees of an entity in charge of configuring the training of the vehicle fleet. Users may also include individuals such as, for example, subscribers, clients, prospective clients, or customers of an entity associated with an organization, such as individuals who have obtained, will obtain, or may obtain a product, service, or consultation from or conduct a transaction in relation to an entity associated with the calibration system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors. In some embodiments, users may also refer to drivers or passengers of vehicles, such as vehicles 401a, 401b, 401c.

The energy management system 320 may include programs (scripts, functions, algorithms) to configure data for visualizations and provide visualizations of datasets and data models on the user device 402. This may include programs to generate graphs and display graphs. The energy management system 320 may include programs to generate histograms, scatter plots, time series, or the like on the user device 402. The energy management system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. The network 406 may be a cellular network, such as 3G, 4G LTE, or 5G. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The calibration system 408 may be associated with and optionally controlled by one or more entities such as a business, corporation, individual, partnership, or any other entity that provides one or more of goods, services, and consultations to individuals such as customers (e.g., an automobile company). In some embodiments, the calibration system 408 may be controlled by a third party on behalf of another business, corporation, individual, partnership. The calibration system 408 may include one or more servers and computer systems for performing one or more functions associated with products and/or services that the organization provides. Vehicles, such as vehicles 401a, 401b, 401c may be configured to complete a calibration phase. The calibration phase may include gathering vehicle and driver data over a short period of time to build the master database of vehicle user behavior. In some embodiments, the calibration phase may be completed by the energy management system 320 from input data in the vehicle at an individual level specific to a driver or to a user profile. In some embodiments, the calibration phase may include the energy management system 320 interacting with calibration system 408 and training system 420 for calibration at a fleet level. The energy management system 320 may upload gathered user and vehicle behavior to calibration system 408. This data may be combined and aggregated with data of other vehicles by training system 420. Training system 420 may create training data from the aggregated data that may be transmitted to the energy management systems 320 of individual vehicles. Training system 420 may comprise one or more machine learning models. The training data may be used to enhance the performance of the energy management system 320. For example, the training system 420 may aggregate data to generate training data indicating that the compressor may be reduced to 50% power when the remainder of the route is on roads when the speed limit is less than 40 miles per hour, instead of only reducing the compressor to 60% power. By transmitting the training data to the energy management systems 320 of individual vehicles, energy savings can increase.

In some embodiments, user settings from vehicles (e.g., vehicles 401a, 401b, 401c) may be crowdsourced and transmitted to the training system 420. The settings may be specific to certain drives or certain vehicle models. Crowdsourcing settings may enhance the performance of energy management system 320 during calibration.

Web server 410 may include a computer system configured to generate and provide one or more websites accessible to customers or vehicles (e.g., vehicles 401a, 401b, 401c), as well as any other individuals involved in accessing calibration system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402 or vehicles 401a, 401b, 401c. For example, web server 410 may host a financial service provider website that a user device may access by providing an attempted login that are authenticated by the training system 420. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™

The local network 412 may include any type of computer networking arrangement used to exchange data in a localized area, such as WiFi, Bluetooth™, Ethernet, and other suitable network connections that enable components of the calibration system 408 to interact with one another and to connect to the network 406 for interacting with components in the system 400 environment. In some embodiments, the local network 412 may include an interface for communicating with or linking to the network 406. In other embodiments, certain components of the calibration system 408 may communicate via the network 406, without a separate local network 406.

The calibration system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access calibration system 408 using the cloud computing environment. User device 402 may be able to access calibration system 408 using specialized software. The cloud computing environment may eliminate the need to install specialized software on user device 402.

In accordance with certain example implementations of the disclosed technology, the calibration system 408 may include one or more computer systems configured to compile data from a plurality of sources (e.g., data provided from vehicles 401a, 401b, 401c or the energy management system 320 of each of those vehicles respectively), web server 410, and/or the database 416. The training system 420 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include location data, velocity data, position data, demographic data, public data, government data, environmental data, traffic data, network data, video data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

Although the preceding description describes various functions of a web server 410, a training system 420, a database 416, in some embodiments, some or all of these functions may be carried out by a single computing device.

FIG. 5 is a block diagram of an example vehicle system 500 that may provide data to and receive instructions from energy management system 320. The components and arrangements shown in FIG. 5 are not intended to limit the disclosed embodiments as the components used to implement the disclosed processes and features may vary. As shown, vehicle system 500 may include an energy management system 320, one or more body control modules 510, one or more compressor control modules 520, one or more pump control modules 530, one or more climate control modules 540, one or more drive unit control modules 550, one or more driver input controls 560, and one or more communications interfaces 570 connected via a vehicle network 506.

Energy management system 320 may receive input data from or issue instructions to each of the other modules in vehicle system 500 via the vehicle network 506. The vehicle network 506 may be a can-bus, ethernet, or other vehicle network. The vehicle network may be similar to network 406 of FIG. 4. The vehicle network may be connected to a communications interface 570, which may include a wireless connection, such as a WiFi connection or cellular connection for interacting with a mobile device of a user or calibration system 408.

Energy management system 320 may interact with a variety of vehicle systems via associated modules via the vehicle network 506 within the vehicle system 500. The body control module 510 may control lighting 511 or other features of the vehicle body, such as seat controls, window controls, and door locks. The compressor control module 520 may control one or more compressors 521. The pump control module 530 may control one or more oil pumps 531 for one or more drive units or one or more coolant pumps 532 for cooling the battery pack and/or drive units. The climate control module 540 may control the cabin HVAC 541, seat heaters and/or seat coolers 542, and the cabin fan 543. The drive unit control module 550 may control one or more drive units 551. Energy management system 320 may receive inputs from driver input control 560, which may include a multimedia system. Driver input control 560 may monitor throttle inputs 561, navigation input 562, and climate control inputs 563, among other inputs.

Although the preceding description describes various functions of a vehicle system 500 separated into different components and modules, in some embodiments, some or all of these functions may be carried out by a single computing device.

### EXAMPLE USE CASES

The following example use cases describe examples of a typical flow pattern using the above energy management system. This section is intended solely for explanatory purposes and not in limitation.

### Example 1

In one example, John is driving home from work which is about a 20 minute drive that he is routinely completes on weekdays. Energy management system 320 continuously monitors the drive by receiving input data, such as location (e.g., block 102). Since the drive starts taking place at 5:45 PM on a weekday, energy management system 320 determines that the anticipated destination is John's house, based on the time, day, current location, and route (e.g., block 104). As John is leaving work, and throughout the drive, energy management system 320 determines that the vehicle is not within five minutes of reaching John's house (e.g., block 106). Therefore, energy management system 320 maintains the standard performance characteristics of the vehicle (e.g., block 120). At around 6:00 PM, John's vehicle is about 5 minutes from his house. Energy management system 320 receives cellular data of the vehicle indicating the position (e.g., block 102). Because the route conforms to John traveling home, the anticipated destination remains John's house (e.g., block 104). Since John's vehicle is now within 5 minutes of arriving at its destination (e.g., block 106), the energy management system 320 begins to reduce the power of the air conditioning system to 50% and reduces the power of coolant pumps for the battery and drive unit to 30% to conserve energy (e.g., block 110). During the final 5 minutes of the drive, John does not notice the power reduction in the air conditioning system, as the temperature in the vehicle changed less than one degree. Furthermore, John only travels on neighborhood roads for the final 5 minutes of the drive, so additional power from the drive unit and battery are unneeded. The drive unit and battery temperatures remain within acceptable levels because large power requests are not made. Because the power of the air conditioning system and coolant pumps are reduced during the final 5 minutes of the drive, John arrives home with a 45% state of charge in the battery of his vehicle instead of 43% state of charge (which would have occurred without the actions of energy management system 320). Accordingly, John's vehicle has a higher state of charge because the vehicle consumed less energy during the drive; therefore, John does not have to pay as much to recharge his vehicle to full.

### Example 2

A typical driver may use an electric or hybrid vehicle to travel, including common trips, such as a commute from home to work. Accordingly, if the outside temperature is cold, the driver needs the cabin to be warm to be comfortable. An energy management system (e.g., energy management system 320) may be used to reduce energy usage while maintaining driver comfort.

The energy management system may be a standalone module or may operate as part of a vehicle control unit (VCU) or body control unit (BCU). Accordingly, the energy management system may receive inputs from a variety of vehicle systems. The energy management system may receive or retrieve vehicle location information (e.g., via GPS), topographical and altitude data for the vehicle's route, and vehicle occupancy data (e.g., from an occupancy classification system or driver monitoring system which can be used to determine a driver's sex, weight, and attire, such as the number of clothing layers). The energy management system may include a machine learning model which may be trained on, and/or iteratively learns, driver/user behavior. The machine learning model may be used to determine a projected route or destination of the vehicle during a drive.

After the projected destination is determined, the energy management system may determine a timeline to reduce energy usage as the vehicle approaches the destination. The timeline may include events or levels that may occur a specific distance (e.g., 5 miles from destination, 4 miles from destination, 2 miles from destination, or 1 mile from destination) or a specific time (e.g., arrival in 5 minutes, arrival in 4 minutes, arrival in 2 minutes, arrival in 1 minute) from the destination. The energy management system may group performance reductions based on the events or levels. The energy management system may be capable of transmitting instructions to the following systems to change the energy consumption: coolant pumps, oil pumps, cabin blower fan, seat heaters, seat ventilation, air conditioning compressor, front defroster, rear defroster, high-voltage battery heater, radiator fan, heat pump systems, converters and inverters (e.g., high voltage DC to low voltage DC converters), and advanced driver-assistance system (ADAS).

As the vehicle travels, the power usage of associated systems may vary over time. Overall, the energy usage of the vehicle increases as the vehicle travels. Accordingly, the levels or events generated by the energy management system may reduce the power consumption over time, thereby reducing the energy usage as the vehicle travels (e.g., flattening a graphed curve of energy usage as time proceeds). Accordingly, the net energy saved per drive cycle may be calculated by determining the area between the typical energy used and the energy used with the levels or events of the energy management system in use. This energy saved may be displayed by the vehicle or transmitted to the manufacturer or fleet manager.

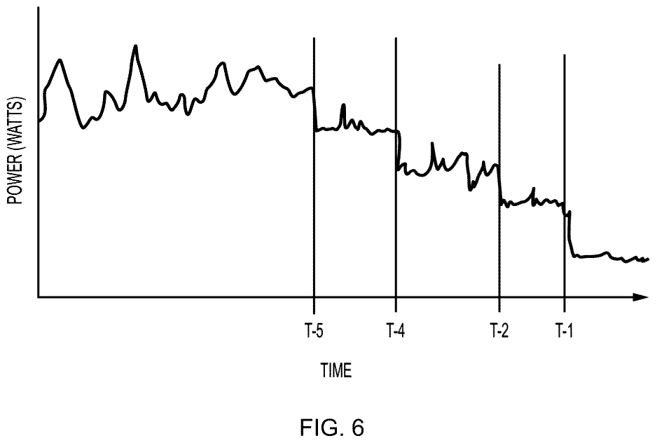

As shown in FIG. 6, each of the levels or events may be accompanied by specific reductions in power as the vehicle gets closer to the destination. The energy management system may transmit instructions to various vehicle systems as the vehicle gets close to the destination to reduce power and conserve energy. The levels may be characterized as T-5, T-4, T-2, and T-1 (e.g., time to destination less X minutes), as shown in FIG. 6. The tables below indicate example changes in energy usage by device or system at each of the levels, expressed as a reduction in power from typical performance when the vehicle is operating in a cool environment.

As shown in Table 1, at the T-5 level, the energy management system may instruct a low-level power reduction that may average about-15% below typical operating power across several systems when the vehicle is 5 minutes from the destination. After 60 seconds at this level, the energy management system may proceed to the T-4 level.

TABLE 1
T-5 level power reductions
Example Phased Energy Reduction at T-5 Level

| Device | Power (%) | Device | Power (%) |
|---|---|---|---|
| Coolant Pump 1 | −20% | AC Compressor | −10% |
| Coolant Pump 2 | −20% | Front Defroster | Unchanged |
| Coolant Pump 3 | −20% | Rear Defroster | −30% |
| Seat Heater | −20% | Battery Heater | −30% |
| Seat Ventilator | N/A | Radiator Fan | −20% |
| Oil Pump | −10% | ADAS ECU | −20% |
| Cabin Fan | −10% | DC to DC Converter | −20% |

As shown in Table 2, At the T-4 level, the energy management system may instruct a moderate power reduction when the vehicle is 4 minutes from the destination. After 120 seconds at this level, the energy management system may proceed to the T-2 level.

TABLE 2
T-4 level power reductions
Example Phased Energy Reduction at T-4 Level

| Device | Power (%) | Device | Power (%) |
|---|---|---|---|
| Coolant Pump 1 | −40% | AC Compressor | −20% |
| Coolant Pump 2 | −40% | Front Defroster | Unchanged |
| Coolant Pump 3 | −40% | Rear Defroster | −50% |
| Seat Heater | −40% | Battery Heater | −50% |
| Seat Ventilator | N/A | Radiator Fan | −30% |
| Oil Pump | −30% | ADAS ECU | −30% |
| Cabin Fan | −10% | DC to DC Converter | −30% |

As shown in Table 3, At the T-2 level, the energy management system may instruct a severe power reduction when the vehicle is 2 minutes from the destination. After 60 seconds at this level, the energy management system may proceed to the T-1 level.

TABLE 3
T-2 level power reductions
Example Phased Energy Reduction at T-2 Level

| Device | Power (%) | Device | Power (%) |
|---|---|---|---|
| Coolant Pump 1 | −70% | AC Compressor | −50% |
| Coolant Pump 2 | −70% | Front Defroster | −50% |
| Coolant Pump 3 | −70% | Rear Defroster | −100% |
| Seat Heater | −100% | Battery Heater | −70% |
| Seat Ventilator | N/A | Radiator Fan | −60% |
| Oil Pump | −60% | ADAS ECU | −60% |
| Cabin Fan | −50% | DC to DC Converter | −50% |

As shown in Table 4, At the T-1 level, the energy management system may instruct a very severe power reduction when the vehicle is 1 minute from the destination. The vehicle may continue to hold these levels until the end of the trip. User input may override the energy management system. For example, if the energy management system determines that the destination of the trip is not as expected, the energy management system may return to one of the prior levels or discontinue power reductions entirely. The energy management system may also be overridden by thermal needs of the vehicle (e.g., the coolant pumps may be activated at T-1 if the vehicle components begin to overheat).

TABLE 4
T-1 level power reductions
Example Phased Energy Reduction at T-1 Level

| Device | Power (%) | Device | Power (%) |
|---|---|---|---|
| Coolant Pump 1 | −100% | AC Compressor | −100% |
| Coolant Pump 2 | −100% | Front Defroster | −100% |
| Coolant Pump 3 | −100% | Rear Defroster | −100% |
| Seat Heater | −100% | Battery Heater | −100% |
| Seat Ventilator | N/A | Radiator Fan | −100% |
| Oil Pump | −80% | ADAS ECU | −100% |
| Cabin Fan | −80% | DC to DC Converter | −50% |

The energy management system may modify power reductions for individual systems in the levels, change the duration or start time of the levels, add levels, subtract levels, ramp and/or smooth the change in power reduction between the levels, and make modifications based on driver/user behavior. The modifications to the levels may be completed using a machine learning model that adapts to and learns from driver/user behavior, vehicle data, and other data (e.g., data provided by the manufacturer) over time. Accordingly, if the energy management system receives input indicating that the driver frequently turns the seat heater back on after the reduction at T-4 when the weather is cold, the energy management system may keep the seat heater at-20% (the power at T-5) for longer (e.g., until the vehicle is 30 seconds from the expected destination). Feedback loops may also be used by the energy management system to modify the power reductions. The energy management system may model the specific heat, latent heat, and insulative or conductive properties of the vehicle and/or occupants when determining the associated power reductions to minimize the tangible effects on the occupants.

In some examples, disclosed systems or methods may involve one or more of the following clauses:

Clause 1: A control system for a vehicle comprising: one or more processors; a memory in communication with the one or more processors and storing instructions that, when executed by the one or more processors, are configured to cause the control system to: receive input data comprising a location of the vehicle, a speed of the vehicle, a direction of vehicle, and vehicle status information; determine, in real-time, using a first machine learning model, an anticipated destination of the vehicle based on at least a portion of the input data; determine whether the vehicle is within a predetermined distance of the anticipated destination or whether the vehicle is anticipated to arrive at the anticipated destination within a predetermined time; and responsive to determining that the vehicle is within the predetermined distance of the anticipated destination or determining that the vehicle is anticipated to arrive at the anticipated destination within the predetermined time: alter the performance of the vehicle using one or more preset tables, the one or more preset tables being used to reduce a power output of one or more drive units or one or more climate control systems.

Clause 2: The control system of clause 1, wherein: vehicle status information comprises an energy consumption of the vehicle based on an energy consumption of the one or more drive units and the one or more climate control systems.

Clause 3: The control system of clause 2, wherein: the vehicle status information further comprises a vehicle load based at least in part on passenger load, cargo load, towing load, vehicle drag, or combinations thereof.

Clause 4: The control system of clause 1, wherein the one or more preset tables further comprises: one or more first power levels for the one or more drive units, one or more second power levels for the one or more climate control systems, and a choice of a first level of the one or more first power levels and a second level of one or more second power levels are based on a distance to the anticipated destination or a time to the anticipated destination.

Clause 5: The control system of clause 1, wherein the memory stores further instructions that, when executed by the one or more processors, are further configured to cause the control system to: determine an anticipated route to the anticipated destination; receive additional data indicating the vehicle has deviated from the anticipated route to the anticipated destination; determine, using the additional data, whether the vehicle is traveling to the anticipated destination using an alternative route; responsive to determining the vehicle is traveling to the anticipated destination: determine whether the vehicle is within a predetermined distance of the anticipated destination or whether the vehicle is anticipated to arrive at the anticipated destination within a predetermined time using the alternative route; responsive to determining that the vehicle is within the predetermined distance of the anticipated destination or determining that the vehicle is anticipated to arrive at the anticipated destination within the predetermined time using the alternative route: maintain one or more altered performance characteristics of the vehicle using the one or more preset tables; and responsive to determining that the vehicle is not within the predetermined distance of the anticipated destination or determining that the vehicle is not anticipated to arrive at the anticipated destination within the predetermined time using the alternative route: cease the one or more altered performance characteristics of the vehicle.

Clause 6: The control system of clause 5, wherein the memory stores further instructions that, when executed by the one or more processors, are further configured to cause the control system to: responsive to determining the vehicle is not traveling to the anticipated destination: determine, using the first machine learning model, a revised anticipated destination of the vehicle based on at least a portion of the input data and the additional data; determine whether the vehicle is within a predetermined distance of the revised anticipated destination or whether the vehicle is anticipated to arrive at the revised anticipated destination within a predetermined time; responsive to determining that the vehicle is within the predetermined distance of the revised anticipated destination or determining that the vehicle is anticipated to arrive at the revised anticipated destination within the predetermined time: alter the performance of the vehicle using one or more preset tables, the one or more preset tables used to reduce a power output of one or more drive units or one or more climate control systems; and responsive to determining that the vehicle is not within the predetermined distance of the revised anticipated destination or determining that the vehicle is not anticipated to arrive at the revised anticipated destination within the predetermined time: maintain a standard performance of the vehicle.

Clause 7: The control system of clause 6, wherein: the anticipated route to the anticipated destination is determined based on driver data associated with past routes, and determining, using the first machine learning model, the anticipated destination and the revised anticipated destination is at least in part based on the driver data.

Clause 8: The control system of clause 1, wherein the memory stores further instructions that, when executed by the one or more processors, are further configured to cause the control system to: receive a driver command to override the one or more altered performance characteristics of the vehicle; cease the one or more altered performance characteristics of the vehicle; determine whether a predetermined time has passed since the driver command to override the one or more altered performance characteristics; and responsive to determining whether the predetermined time has passed since the driver command to override the one or more altered performance characteristics: resume the altered performance characteristics of the vehicle.

Clause 9: A control system for a vehicle comprising: one or more processors; a memory in communication with the one or more processors and storing instructions that, when executed by the one or more processors, are configured to cause the control system to: receive input data; determine, using a first machine learning model, an anticipated destination of the vehicle based on at least a portion of the input data; determine whether the vehicle is anticipated to arrive at the anticipated destination within a predetermined time; and responsive to determining that the vehicle is anticipated to arrive at the anticipated destination within the predetermined time: change an operating mode of the vehicle from a first operating mode to a second operating mode, wherein the second operating mode is an energy conservation mode.

Clause 10: The control system of clause 9, wherein: the input data comprises user data specific to an operator of the vehicle, the input data comprises vehicle data, comprising: a location of the vehicle; a speed of the vehicle; a direction of the vehicle; a load of the vehicle; a throttle setting of the vehicle, and a temperature setting in the vehicle, the first operating mode is a standard operating mode, and the second operating mode comprises one or more preset tables with one or more levels.

Clause 11: The control system of clause 10, wherein: a first level of the one or more levels is used when the vehicle is anticipated to arrive at the anticipated destination within 5 minutes, a second level of the one or more levels is used when the vehicle is anticipated to arrive at the anticipated destination within 2 minutes, and a third level of the one or more levels is used when the vehicle is anticipated to arrive at the anticipated destination within 1 minute.

Clause 12: The control system of clause 10, wherein: the one or more preset tables reduce compressor power, battery pump power, oil pump power, cabin heating, ventilation, and air conditioning power, seat heating power, seat cooling power, cabin fan power, or combinations thereof.

Clause 13: The control system of clause 10, wherein the memory stores further instructions that, when executed by the one or more processors, are further configured to cause the control system to: receive updated input data; update the anticipated destination of the vehicle using the updated input data; and change the operating mode of the vehicle based on the updated anticipated destination.

Clause 14: The control system of clause 10, wherein the memory stores further instructions that, when executed by the one or more processors, are further configured to cause the control system to: receive a first user request exceeding one or more capabilities of the vehicle when in the second operating mode; and change from the second operating mode to the first operating mode.

Clause 15: The control system of clause 10, the memory stores further instructions that, when executed by the one or more processors, are further configured to cause the control system to: determine whether the anticipated destination is a final destination; and responsive to determining the anticipated destination is not a final destination: maintain the operating mode of the vehicle in the first operating mode.

Clause 16: The control system of clause 9, wherein: the second operating mode comprises one or more stages, and the memory stores further instructions that, when executed by the one or more processors, are further configured to cause the control system to: determine, using a second machine learning model, a selected stage of the one or more stages based on the input data.

Clause 17: A method for controlling a vehicle comprising: receiving input data; determining, using a first machine learning model, an anticipated destination of the vehicle based on at least a portion of the input data; determining that the vehicle is anticipated to arrive at the anticipated destination within a predetermined time threshold; and responsive to determining that the vehicle is anticipated to arrive at the anticipated destination within the predetermined time threshold, changing an operating mode of the vehicle from a first operating mode to a second operating mode, wherein the second operating mode is an energy conservation mode.

Clause 18: The method of clause 17, wherein: the first operating mode is a standard operating mode, and the second operating mode comprises one or more preset tables with one or more levels for reducing power consumption.

Clause 19: The method of clause 18, wherein the one or more levels further comprise: reducing the power consumption of one or more drive units, and reducing the power consumption of one or more climate control systems.

Clause 20: The method of clause 19, further comprising: receiving updated input data; updating the anticipated destination of the vehicle using the updated input data; and responsive to the updated anticipated destination, changing the operating mode of the vehicle from the second operating mode to the first operating mode by: increasing the available power consumption of the one or more drive units, and increasing the available power consumption of the one or more climate control systems.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IOT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A control system for a vehicle comprising:
one or more processors;
a memory in communication with the one or more processors and storing instructions that, when executed by the one or more processors, are configured to cause the control system to:
receive input data comprising a location of the vehicle, a speed of the vehicle, a direction of vehicle, and vehicle status information;
determine, in real-time, using a first machine learning model, an anticipated destination of the vehicle based on at least a portion of the input data;
determine whether the vehicle is within a predetermined distance of the anticipated destination or whether the vehicle is anticipated to arrive at the anticipated destination within a predetermined time; and
responsive to determining that the vehicle is within the predetermined distance of the anticipated destination or determining that the vehicle is anticipated to arrive at the anticipated destination within the predetermined time:
alter the performance of the vehicle using one or more preset tables, the one or more preset tables being used to reduce a power output of one or more drive units or one or more climate control systems.

2. The control system of claim 1, wherein:
vehicle status information comprises an energy consumption of the vehicle based on an energy consumption of the one or more drive units and the one or more climate control systems.

3. The control system of claim 2, wherein:
the vehicle status information further comprises a vehicle load based at least in part on passenger load, cargo load, towing load, vehicle drag, or combinations thereof.

4. The control system of claim 1, wherein the one or more preset tables further comprises:
one or more first power levels for the one or more drive units,
one or more second power levels for the one or more climate control systems, and
a choice of a first level of the one or more first power levels and a second level of one or more second power levels are based on a distance to the anticipated destination or a time to the anticipated destination.

5. The control system of claim 1, wherein the memory stores further instructions that, when executed by the one or more processors, are further configured to cause the control system to:
determine an anticipated route to the anticipated destination;
receive additional data indicating the vehicle has deviated from the anticipated route to the anticipated destination;
determine, using the additional data, whether the vehicle is traveling to the anticipated destination using an alternative route;
responsive to determining the vehicle is traveling to the anticipated destination:
determine whether the vehicle is within a predetermined distance of the anticipated destination or whether the vehicle is anticipated to arrive at the anticipated destination within a predetermined time using the alternative route;
responsive to determining that the vehicle is within the predetermined distance of the anticipated destination or determining that the vehicle is anticipated to arrive at the anticipated destination within the predetermined time using the alternative route:
maintain one or more altered performance characteristics of the vehicle using the one or more preset tables; and
responsive to determining that the vehicle is not within the predetermined distance of the anticipated destination or determining that the vehicle is not anticipated to arrive at the anticipated destination within the predetermined time using the alternative route:
cease the one or more altered performance characteristics of the vehicle.

6. The control system of claim 5, wherein the memory stores further instructions that, when executed by the one or more processors, are further configured to cause the control system to:
responsive to determining the vehicle is not traveling to the anticipated destination:
determine, using the first machine learning model, a revised anticipated destination of the vehicle based on at least a portion of the input data and the additional data;
determine whether the vehicle is within a predetermined distance of the revised anticipated destination or whether the vehicle is anticipated to arrive at the revised anticipated destination within a predetermined time;
responsive to determining that the vehicle is within the predetermined distance of the revised anticipated destination or determining that the vehicle is anticipated to arrive at the revised anticipated destination within the predetermined time:
alter the performance of the vehicle using one or more preset tables, the one or more preset tables used to reduce a power output of one or more drive units or one or more climate control systems; and
responsive to determining that the vehicle is not within the predetermined distance of the revised anticipated destination or determining that the vehicle is not anticipated to arrive at the revised anticipated destination within the predetermined time:
maintain a standard performance of the vehicle.

7. The control system of claim 6, wherein:
the anticipated route to the anticipated destination is determined based on driver data associated with past routes, and
determining, using the first machine learning model, the anticipated destination and the revised anticipated destination is at least in part based on the driver data.

8. The control system of claim 1, wherein the memory stores further instructions that, when executed by the one or more processors, are further configured to cause the control system to:
receive a driver command to override the one or more altered performance characteristics of the vehicle;
cease the one or more altered performance characteristics of the vehicle;
determine whether a predetermined time has passed since the driver command to override the one or more altered performance characteristics; and
responsive to determining whether the predetermined time has passed since the driver command to override the one or more altered performance characteristics:
resume the altered performance characteristics of the vehicle.

9. A control system for a vehicle comprising:
one or more processors;
a memory in communication with the one or more processors and storing instructions that, when executed by the one or more processors, are configured to cause the control system to:
receive input data;
determine, using a first machine learning model, an anticipated destination of the vehicle based on at least a portion of the input data;
determine whether the vehicle is anticipated to arrive at the anticipated destination within a predetermined time; and
responsive to determining that the vehicle is anticipated to arrive at the anticipated destination within the predetermined time:
change an operating mode of the vehicle from a first operating mode to a second operating mode, wherein the second operating mode is an energy conservation mode.

10. The control system of claim 9, wherein:
the input data comprises user data specific to an operator of the vehicle,
the input data comprises vehicle data, comprising:
a location of the vehicle;
a speed of the vehicle;
a direction of the vehicle;
a load of the vehicle;
a throttle setting of the vehicle, and
a temperature setting in the vehicle,
the first operating mode is a standard operating mode, and
the second operating mode comprises one or more preset tables with one or more levels.

11. The control system of claim 10, wherein:
a first level of the one or more levels is used when the vehicle is anticipated to arrive at the anticipated destination within 5 minutes,
a second level of the one or more levels is used when the vehicle is anticipated to arrive at the anticipated destination within 2 minutes, and
a third level of the one or more levels is used when the vehicle is anticipated to arrive at the anticipated destination within 1 minute.

12. The control system of claim 10, wherein:
the one or more preset tables reduce compressor power, battery pump power, oil pump power, cabin heating, ventilation, and air conditioning power, seat heating power, seat cooling power, cabin fan power, or combinations thereof.

13. The control system of claim 10, wherein the memory stores further instructions that, when executed by the one or more processors, are further configured to cause the control system to:
receive updated input data;
update the anticipated destination of the vehicle using the updated input data; and
change the operating mode of the vehicle based on the updated anticipated destination.

14. The control system of claim 10, wherein the memory stores further instructions that, when executed by the one or more processors, are further configured to cause the control system to:
receive a first user request exceeding one or more capabilities of the vehicle when in the second operating mode; and
change from the second operating mode to the first operating mode.

15. The control system of claim 10, wherein the memory stores further instructions that, when executed by the one or more processors, are further configured to cause the control system to:
determine whether the anticipated destination is a final destination; and
responsive to determining the anticipated destination is not a final destination:
maintain the operating mode of the vehicle in the first operating mode.

16. The control system of claim 9, wherein:
the second operating mode comprises one or more stages, and
the memory stores further instructions that, when executed by the one or more processors, are further configured to cause the control system to:
determine, using a second machine learning model, a selected stage of the one or more stages based on the input data.

17. A method for controlling a vehicle comprising:
receiving input data;
determining, using a first machine learning model, an anticipated destination of the vehicle based on at least a portion of the input data;
determining that the vehicle is anticipated to arrive at the anticipated destination within a predetermined time threshold; and
responsive to determining that the vehicle is anticipated to arrive at the anticipated destination within the predetermined time threshold, changing an operating mode of the vehicle from a first operating mode to a second operating mode, wherein the second operating mode is an energy conservation mode.

18. The method of claim 17, wherein:
the first operating mode is a standard operating mode, and
the second operating mode comprises one or more preset tables with one or more levels for reducing power consumption.

19. The method of claim 18, wherein the one or more levels further comprise:
reducing the power consumption of one or more drive units, and
reducing the power consumption of one or more climate control systems.

20. The method of claim 19, further comprising:
receiving updated input data;
updating the anticipated destination of the vehicle using the updated input data; and
responsive to the updated anticipated destination, changing the operating mode of the vehicle from the second operating mode to the first operating mode by:
increasing the available power consumption of the one or more drive units, and
increasing the available power consumption of the one or more climate control systems.
